(19) United States
(12) Patent Application Publication
(10) Pub. No.: US 2022/0032627 A1
(43) Pub. Date: Feb. 3, 2022

(54) INKJET PRINTING APPARATUS

(71) Applicant: Konica Minolta, Inc., Tokyo (JP)

(72) Inventors: Takuya OKADA, Toyokawa-shi (JP); Ken NITO, Tokyo (JP); Masaki NAKAMURA, Tokyo (JP)

(21) Appl. No.: 17/331,030

(22) Filed: May 26, 2021

(30) Foreign Application Priority Data
Aug. 3, 2020 (JP) 2020-131431

(51) Int. Cl. B41J 2/165

(52) U.S. Cl. CPC B41J 2/16552

(57) ABSTRACT

Provided is an inkjet printing apparatus for printing an aqueous ink on a fabric containing: a printing device for ejecting the aqueous ink onto the fabric; a coating device located downstream of the printing device for applying a cleaning liquid containing no eluate from the fabric to the fabric; and a removing device located downstream of the coating device of the cleaning liquid for removing the cleaning liquid.

### CROSS-REFERENCE TO RELATED APPLICATION

The entire disclosure of Japanese Patent Application No. 2020-131431 filed on Aug. 3, 2020 is incorporated herein by reference in its entirety.

### BACKGROUND

### Technological Field

The present invention relates to an inkjet printing apparatus. More particularly, the present invention relates to an inkjet printing apparatus capable of reducing waste water and reliably removing a colorant, a solvent, and a preservative remaining on a printed fabric with a small amount of cleaning liquid.

### Description of the Related Art

In recent years, an inkjet printing method using an inkjet recording apparatus (printing device) has been used as a method of forming images of characters, pictures, and patterns on fabrics such as a woven fabric and a non-woven fabric. The printing device generally includes an inkjet head having a pressure chamber and a nozzle for ejecting ink in the pressure chamber. Then, droplets of ink are ejected from nozzles provided in the inkjet head, and printing is performed on a fabric to be printed.

Usually, it is necessary to perform a cleaning step after fixing a dye on a fabric by printing and developing a color. For example, in Patent Document 1 (JP-A 3-97953), the printed fabric is passed through a cleaning tank for initial washing. However, when a cleaning tank is used, a large amount of sewage becomes an environmental problem.

On the other hand, in an inkjet printing apparatus which is a dry process, since there is no cleaning step, waste water may be reduced and environmental merit is large. However, it has been difficult to remove a solvent or a preservative necessary for ejection by inkjet and an unnecessary colorant after printing from a printed fabric by an inkjet method. And, the regulation for the skin sensitive substance which remains in the textile product is also advancing.

### SUMMARY

The present invention has been achieved in view of the above problems and status. An object of the present invention is to provide an inkjet printing apparatus capable of reducing waste water and reliably removing a colorant, a solvent, and a preservative remaining on a printed fabric with a small amount of cleaning liquid.

In order to solve the above-mentioned problems, the present inventor has found the following in the process of examining the causes of the above-mentioned problems. In other words, it has been found that, by having a configuration including a printing device for discharging an aqueous ink onto a fabric, a coating device for cleaning a fabric by applying a cleaning liquid to the fabric, and a removing device for removing a cleaning liquid after washing, it is possible to provide an inkjet printing apparatus capable of reducing waste water and reliably removing a colorant, a solvent, and a preservative remaining on the printed fabric, and thus to achieve the present invention. That is, the above problem according to the present invention is solved by the following means.

To achieve at least one of the above-mentioned objects of the present invention, an inkjet printing apparatus that reflects an aspect of the present invention is as follows.

An inkjet printing apparatus for printing an aqueous ink on a fabric comprising: a printing device for ejecting the aqueous ink onto the fabric; a coating device located downstream of the printing device for applying a cleaning liquid containing no eluate from the fabric to the fabric; and a removing device located downstream of the coating device of the cleaning liquid for removing the cleaning liquid.

By the above means of the present invention, it is possible to provide an inkjet printing apparatus capable of reducing waste water and reliably removing a colorant, a solvent, and a preservative remaining on a printed fabric with a small amount of cleaning liquid. The expression mechanism or action mechanism of the effect of the present invention is not clarified, but is inferred as follows. Since the inkjet printing apparatus of the present invention has a configuration including: a printing device for discharging an aqueous ink to a fabric; a coating device located downstream of the printing device for applying a cleaning liquid containing no eluate from the fabric to the fabric; and a removing device located downstream of the coating device of the cleaning liquid for removing the cleaning liquid, and since it is not necessary to pass the fabric through the cleaning tank to wash as in the prior art, so that the waste water may be reduced and the fabric may be washed with a small amount of the cleaning liquid. Further, it is possible to reliably remove the colorant, the solvent, and the preservative remaining on the printed fabric.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram of the inkjet printing apparatus of the present invention.

FIG. 2 is a schematic diagram of a coating device and a removing device.

FIG. 3 is a perspective view of an inkjet head in a printing device.

FIG. 4 is an exploded perspective view of an inkjet head.

FIG. 5 is a cross-sectional view of an inkjet head.

### DETAILED DESCRIPTION OF THE EMBODIMENTS

Hereinafter, one or more embodiments of the present invention will be described. However, the scope of the invention is not limited to the disclosed embodiments.

An inkjet printing apparatus according to the present invention is an inkjet printing apparatus for printing an aqueous ink on a fabric, wherein the inkjet printing apparatus is provided with: a printing device for discharging the aqueous ink; a coating device for applying a cleaning liquid containing no eluate from the fabric to the fabric, located downstream of the printing device; and a removing device for removing the cleaning liquid, located downstream of the coating device of the cleaning liquid. This feature is a technical feature common to or corresponding to each of the following embodiments.

As an embodiment of the present invention, it is preferable that the coating device and the removing device of the cleaning liquid are disposed on the same line in that the application and removal may be performed continuously without winding.

In addition, it is preferable that the coating device for applying the cleaning liquid applies the cleaning liquid to the fabric in a non-contact manner in terms of preventing damage and image deterioration of the fabric.

It is preferable that the aqueous ink contains at least a pigment in terms of small amount of unbound colorant after fixing and sufficiently cleaning the fabric with a small amount of cleaning liquid. In addition, it is preferable that the aqueous ink is a disperse ink in that it is less dissolved in a cleaning liquid and a colorant hardly remains after passing through a removing device.

It is preferable that the coating device for applying the cleaning liquid is a mist coating device or a spray coating device in that unnecessary colorant, solvent, and preservative may be removed from the fabric with a small amount of cleaning liquid.

It is preferable that the removing device of the cleaning liquid is a suction device, a blade removing device or an air blow device in terms of reliably removing the cleaning liquid after coating.

It is preferable that the coating device has a function of controlling the coating amount and the coating region according to conditions in terms of excellent cleaning efficiency of the fabric. In addition, it is preferable that the coating device controls the coating amount and the coating region of the cleaning liquid by the type of the fabric and the printing rate of the aqueous ink.

It is preferable that the coating device and the removing device of the cleaning liquid be installed on both surfaces of the fabric in view of excellent cleaning efficiency of the fabric. In addition, it is preferable that the cleaning liquid to be applied by the coating device of the cleaning liquid contains an additive in view of easy dissolution of a colorant, a solvent, and a preservative in the cleaning liquid. Further, it is preferable to control the temperature of the cleaning liquid to be applied by the coating device in terms of facilitating dissolution of a colorant, a solvent, and a preservative in the cleaning liquid.

It is preferable from an environmental point of view that the cleaning liquid recovered by the removing device is purified and then reused because waste water may be reduced.

Hereinafter, the present invention, its constituent elements, and configurations and embodiments for carrying out the present invention will be described. In the present description, when two figures are used to indicate a range of value before and after “to”, these figures are included in the range as a lowest limit value and an upper limit value.

[Inkjet Printing Apparatus]

An inkjet printing apparatus for printing an aqueous ink on a fabric is characterized in that it comprises: a printing device for discharging the aqueous ink (hereinafter, also simply referred to as “ink”) onto the fabric; a coating device for applying a cleaning liquid containing no eluted matter from the fabric to the fabric, located downstream of the printing device; and a removing device for removing the cleaning liquid, located downstream of the coating device for applying the cleaning liquid.

In the present invention, “printing” refers to a dyeing method in which an ink containing a dye or a pigment is printed (applied) on a fabric (a fabric to be dyed) to give a pattern shape, and a dyed product having a pattern is produced by dyeing or fixing a dyed pigment. In the present invention, an image such as a pattern is fixed by printing an aqueous ink on a fabric and performing heat treatment. In addition, “printing” refers to an operation in which an ink containing a dye or a pigment is ejected and adhered to a portion where a pattern of a fabric is generated. In addition, in the present invention, an “eluate from a fabric” is a colorant, a solvent, a preservative, or a surfactant contained in an aqueous ink discharged onto a fabric, and is an unnecessary substance that remains without being adhered to a fabric. Thus, “cleaning liquid containing no eluate from the fabric” means excluding cleaning liquid stored in the cleaning tank.

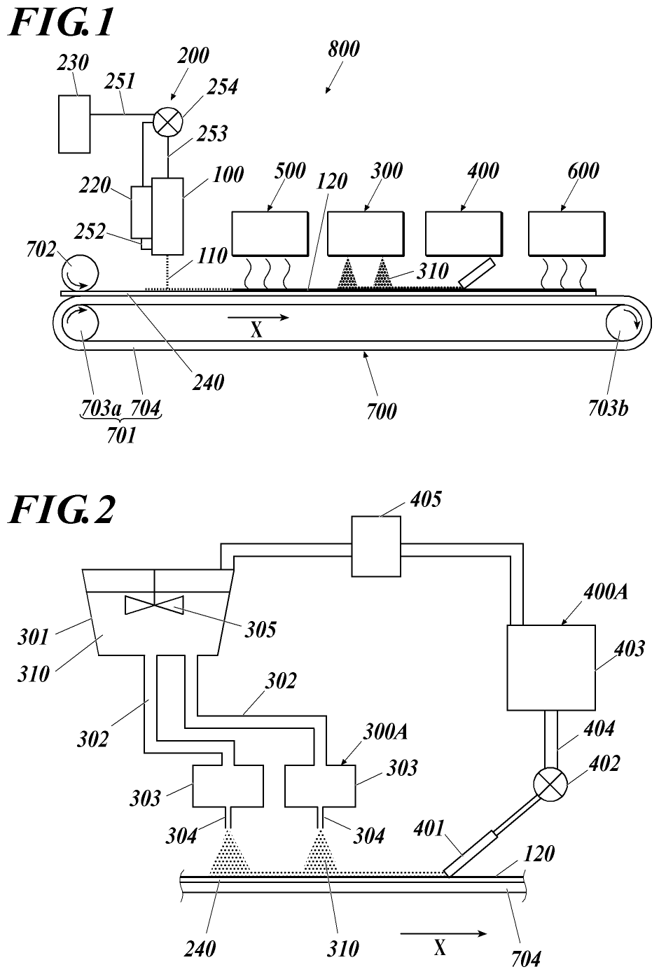

FIG. 1 is a schematic diagram showing a configuration of an inkjet printing apparatus of the present invention. As shown in FIG. 1, the inkjet printing apparatus 800 includes a printing device 200 for discharging at least an aqueous ink 110 to a fabric 240, a coating device 300 for a cleaning liquid 310, and a removing device 400 for the cleaning liquid 310.

Further, the inkjet printing apparatus 800 includes a drying-fixing device 500 which fixes the aqueous ink 110 discharged by the printing device 200 to the fabric 240 by drying and heating on an upstream side of the coating device 300 and downstream of the printing device 200 (downstream of the conveying direction X of the fabric 240) to form an image 120. The drying-fixing device 500 may be provided upstream of the printing device 200 to dry the aqueous ink 110 by heat stored in the fabric 240 before discharge of the aqueous ink 110 by the printing device 200, or may be further disposed on both the upstream side and the downstream side of the fabric 240 of the printing device 200 in the conveying direction X.

Further, it is preferable that the inkjet printing apparatus 800 includes a drying device 600 for drying the fabric 240 after removing the cleaning liquid 310 by the removing device 400. Further, it is preferable that the inkjet printing apparatus 800 includes a conveyance device 700 for conveying the fabric 240 to the printing device 200, the drying-fixing device 500, the coating device 300, the removing device 400, and the drying device 600.

<Coating Device>

The coating device 300 in the present invention is a device for applying a cleaning liquid 310 containing no eluate from the fabric 240 to the fabric 240 and located downstream of the printing device 200. The coating device 300 may be any device capable of applying the cleaning liquid 310 to the fabric 240, and may be, for example, a mist coating device, a spray coating device, a dispenser, or a roller coating device, but it is preferable to apply the cleaning liquid without contact, and for example, it is preferable to be a mist coating device or a spray coating device in view of being able to further reduce waste water and being excellent in cleaning efficiency.

(Spray Coating Device)

The spray coating device is not particularly limited as long as it can eject the cleaning liquid, and for example, a spray coating device 300A as shown in FIG. 2 may be used. In the spray coating device 300A, the supply tank 301 and the coating liquid 310 in the supply tank 301 are pressurized and supplied to the head 303 through the connection pipe 302, and the coating liquid 310 supplied to the head 303 is discharged from the nozzles 304 and is applied to the fabric 240. Discharge of the coating liquid 310 from the nozzle 304 is performed by wind pressure by an air compressor (not shown).

A hole diameter of the tip of the nozzle is preferably in the range of 0.4 to 4 mm, more preferably in the range of 1 to 2.5 mm. It is preferable that the nozzle is movable up and down, left and right, and back and forth. For example, a spray gun W-101-142BPG manufactured by Anest Iwata Corporation may be used as the nozzles, and OFP-071C manufactured by Anest Iwata Corporation may be used as the compressor.

It is preferable that the nozzle is angularly adjustable and may be tilted with respect to the fabric. The angle of the nozzle with respect to the fabric may be adjusted, for example, in the range of 0 to 90° when the horizontal direction is 0 degree. As shown in FIG. 2, a plurality of nozzles 304 are preferably provided along the conveying direction X of the fabric 240.

As shown in FIG. 2, a stir bar 305 is contained in the supply tank 301, and it is preferable that the cleaning liquid 310 is always stirred in terms of being able to hold the cleaning liquid 310 in a dispersed state. For example, PC-51 manufactured by Anest Iwata Corporation may be used as the supply tank.

The compressed air pressure is preferably in the range of 0.05 to 1 MPa. In addition, it is preferred that the distance from the nozzle to the fabric be within a range of 5 to 30 cm.

(Mist Coating Device)

The mist coating device is not particularly limited as long as a mist having a predetermined particle diameter may be generated, and may be, for example, a system in which each of the cleaning liquid and air is compressed and jetted from a nozzle to collide with each other, or a system in which only the cleaning liquid is compressed and jetted from the nozzle into the air.

A hole diameter of the tip of the nozzle of the mist coating device is preferably in the range of 20 to 200 μm. The mist coating device may be a commercially available product, and for example, SFS-104-4 manufactured by Super Industries Co., Ltd. may be used as the mist coating device. The distance from the nozzle to the fabric is preferably within the range of 1 to 20 cm.

It is preferable that the coating device described above has a function of controlling the coating amount and the coating region of the cleaning liquid to be applied according to conditions. Examples of the condition include a type of fabric and a printing rate of an aqueous ink. Examples of the type of the fabric include a material of a fabric, a mass or a fabric type of a weave.

The material of the fabric is not particularly limited, and examples thereof include natural fibers such as cotton (cellulose fibers), silk, and wool, and chemical fibers such as nylon, rayon, polyurethane, polyester, and acrylic resin, or woven fabrics, knitted fabrics, nonwoven fabrics made of composite fibers obtained by combining them.

The mass of the fabric is preferably in the range of, for example, 40 to 300 g/m². As the cloth type of the weaving method, a cloth type in which fibers are woven by a weaving method such as a plain weave, a twill weave, or a satin weave is exemplified.

The printing rate of the aqueous ink is, for example, an average printing rate in a direction (width direction) orthogonal to the conveying direction X of the fabric. The coating device controls the coating amount and the coating region according to the type of the fabric described above and the printing rate of the aqueous ink. For example, it is preferable to control as follows. When the average printing rate exceeds 50%, the amount of the aqueous ink applied is 50 g/m² and the entire surface of the fabric is applied. When the average printing rate is within the range of 20 to 50%, the amount of aqueous ink applied is 20 g/m². When the average printing rate is less than 20%, the amount of the aqueous ink applied is 10 g/m² and the ink is applied to the printed part of the cloth.

Further, it is preferable that the coating device controls the temperature of the cleaning liquid to be applied in terms of excellent cleaning efficiency. Specifically, it is preferable that a temperature sensor is provided in the supply tank in which the cleaning liquid of the coating device is stored, and the cleaning liquid is controlled by the heating or cooling device so as to reach a predetermined temperature by measurement with the temperature sensor.

The temperature of the cleaning liquid is preferably within a range of 15 to 80° C. In addition, it is preferable that the pH of the cleaning liquid (25° C.) is within a range of 5 to 11. Further, as such a cleaning liquid, it is sufficient that the eluate from the cloth is not contained, and examples thereof include pure water, water, ethanol and a mixed liquid of a surfactant, a PH adjuster, and a preservative.

Although the coating device may be installed only on one side of a printing surface of a fabric (see FIG. 1), in terms of cleaning efficiency of the fabric, from the viewpoint of the cleaning efficiency of the cloth, it is preferable to install the coating device on both the printing surface of the fabric and the surface on the opposite side thereof.

<Removing Device>

As shown in FIG. 1, the removing device 400 of the cleaning liquid 310 is a device that removes the cleaning liquid 310 after cleaning at downstream of the coating device 300. As the removing device 400, for example, a suction device, a blade removing device, or an air blow device is preferable in that the cleaning liquid 310 may be reliably removed.

(Suction Device)

As shown in FIG. 2, the suction device 400A is a device which is applied to the fabric 240 to remove the cleaning liquid 310 after washing by suction. The suction device 400A is not particularly limited as long as it may suck the cleaning liquid 310, but, for example, it is preferable to have a configuration including a suction port 401, a suction pump 402 for generating a negative pressure (suction force) in the suction port 401, and a drain tank 403 for storing the sucked cleaning liquid 310 as drain. The suction port 401, the suction pump 402, and the drain tank 403 are preferably connected by a suction tube 404. In such a suction device 400A, when the suction pump 402 is operated, a negative pressure is generated in the suction port 401, and a cleaning liquid 310 in which a colorant, a solvent, and a preservative dissolved is sucked from the fabric 240 after washing, and is stored in the drain tank 403 via the suction tube 404.

It is preferable that the cleaning liquid 310 collected in the drain tank 403 is sent to the supply tank 301 for supplying the cleaning liquid 310 of the coating device 300 after being purified by the purifying device 405, and the drained cleaning liquid 310 is reused.

(Blade Removing Device)

A blade removing device is a device that removes cleaning liquid by contacting a blade with a fabric. The blade removing device is not particularly limited, but, for example, it is preferable that a blade formed in a flat plate shape by an elastic material such as rubber, a PET sheet, or a straight brush is provided, and the blade is spanned over the entire width of the conveying belt that conveys the fabric. Then, although not shown, the blade is provided so that its tip abuts on the surface of the fabric, and the cleaning liquid is removed by scraping off the cleaning liquid after washing applied to the fabric by the movement of the transfer belt. The removed cleaning liquid preferably flows down the surface of the blade and is contained in a drain tank. It is preferable that the drain tank collects the cleaning liquid scraped off by the blade, and the cleaning liquid collected in the drain tank is sent to a supply tank for supplying the cleaning liquid of the coating device after being purified by the purifying device, and the discharged cleaning liquid is reused.

(Air Blow Device)

An air blow device is a device by which a cleaning liquid applied to a fabric is blown off by gas injection and removed. The air blow device is not particularly limited, but it is preferable that a plurality of nozzles are arranged along the conveying direction of the fabric in a gas jetting device in which a plurality of nozzles are formed at the tip end, for example. Further, the nozzle is preferably connected by a high-pressure gas supply source and the pipe. In such an air blow device, a high-pressure gas is injected onto the conveyed fabric after cleaning to blow off the cleaning liquid after cleaning applied to the fabric. It is preferable to provide a drain tank for collecting the cleaning liquid blown off by the gas phase jetting from the nozzle. It is preferable that the cleaning liquid collected in the drain tank is sent to a supply tank for supplying the cleaning liquid of the coating device after being purified by the purifying device, and the discharged cleaning liquid is reused.

Although the above-described removing device may be installed only on one side of a printing surface of a fabric (see FIG. 1), in terms of removal efficiency of the cleaning liquid, it is preferable to install the removing device on both surfaces of the printing surface of the fabric and the opposite side thereof.

It is preferable that the coating device and the removing device are installed on the same line. Specifically, it is preferable that the coating device and the removing device are installed on the same conveying belt, and the coating and removing are performed continuously.

Note that, as shown in FIG. 1, a drying device 600 may be provided downstream of the removing device 400 for drying the fabric 240 after removing the cleaning liquid 310 by the removing device 400. The drying device 600 is not particularly limited, and may be a heat roll, or an iron.

<Conveyance Device>

The conveyance device 700 is a device for conveying the fabric 240 to the printing device 200, the drying-fixing device 500, the cleaning liquid coating device 300, the cleaning liquid removing device 400, and the drying device 600. The conveyance device 700 includes, for example, a belt conveyor 701 and a rotatable feed roller 702, although not particularly limited thereto. The belt conveyor 701 includes rotatable pulleys 703a and 703b, and an endless conveying belt 704 stretched on the pulleys 703a and 703b. The feeding roller 702 is disposed at a position facing the pulley 703a on the upstream side in the conveying direction X of the fabric 240 so as to sandwich the conveying belt 704 and the fabric 240 and feed the fabric 240 onto the conveying belt 704.

The conveying speed of the fabric is preferably within a range of 30 to 200 m/h.

<Printing Device>

The printing device 200 includes an inkjet head 100, an ink supply device 220, and a main tank 230.

The inkjet head 100 is disposed so as to be able to scan in a direction transverse to the conveying direction X of the fabric 240 on which the image 120 is to be formed, for example. The inkjet head 100 has a plurality of nozzles for ejecting ink droplets of the ink (aqueous ink) 110 onto the fabric 240. The inkjet head 100 is configured such that, for example, a plurality of types of inks having different colors are supplied to corresponding nozzles. The configuration of the inkjet head 100 will be described later.

The ink supply device 220 is disposed integrally with the inkjet head 100. The ink supply device 220 is disposed for each type of ink. For example, when 4 colors of ink of Y (yellow), M (magenta), C (cyan) and K (black) are used, 4 ink supply devices 220 are disposed in the inkjet head 100.

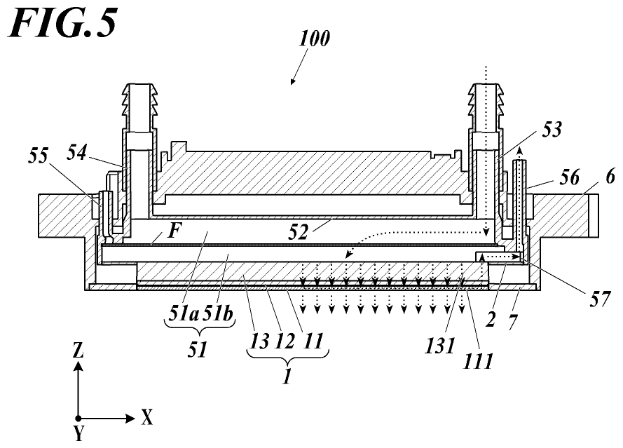

The ink in the main tank 230 is supplied to the ink supply device 220 through the flow passage 251 and the valve 254 connected to the main tank 230. The ink supply device 220 communicates with the common ink chamber 51 (ink chamber) (see FIG. 5) of the inkjet head 100 via the flow path 252, and is connected so as to supply the ink of each color to the first ink port 53 (see FIG. 5) communicating with the common ink chamber 51.

The inkjet head 100 is also connected to the main tank 230 by a bypass flow passage 253 branching from the flow passage 251. At a branch point between the flow path 251 and the bypass flow path 253, a valve 254 that can switch and set the flow path of the ink is disposed in one or both of the flow path 251 and the bypass flow path 253. The flow path 251, the flow path 252, and the bypass flow path 253 are, for example, flexible tubes. The valve 254 is, for example, a three-way valve.

The main tank 230 is a tank for containing the ink to be supplied to the inkjet head 100. The main tank 230 is disposed separately from the inkjet head 100. The main tank 230 includes, for example, a stirring device (not shown). The main tank 230 may be appropriately determined according to the image forming performance and the size of the marking device 200. For example, when the imaging rate of the printing device 200 is 1 to 3 m²/min, the volume of the main tank 230 is, for example, 1 L.

(Inkjet Head 100)

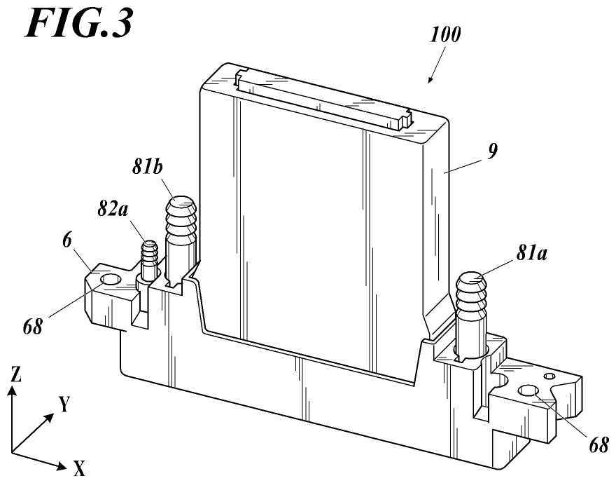

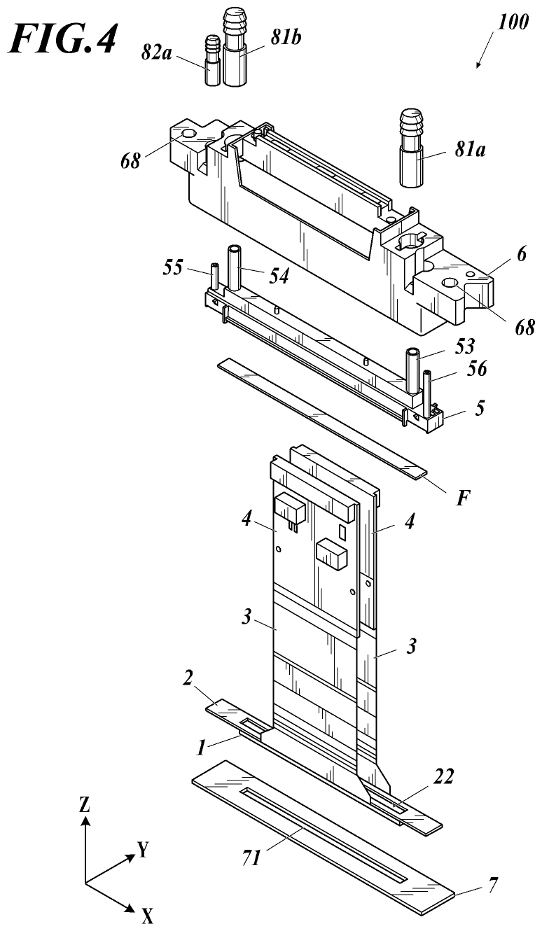

FIG. 3 is a perspective view of the inkjet head 100 in the printing device 200 of FIG. 1. FIG. 4 is an exploded perspective view of the inkjet head 100. FIG. 5 is a cross-sectional view of an inkjet head 100. In FIG. 4 and FIG. 5, a cover member 9 is omitted.

Inkjet head 100 of the present embodiment has, as shown in FIG. 4, a head chip 1, a wiring board 2, a flexible substrate 3, a drive circuit board 4, a manifold 5, a case 6, a cap receiving plate 7, and a cover member 9 (see FIG. 3). Hereinafter, the stacking direction of these members is defined as a Z direction. In the plane orthogonal to the Z direction, the direction parallel to the transport direction of the fabric is defined as an X direction, and the direction orthogonal to the X direction is defined as a Y direction.

The head chip 1 includes a nozzle substrate 11, a flow path spacer substrate 12, and a pressure chamber substrate 13.

A wiring board 2 has an opening 22 substantially in the center. On one surface of the wiring board 2, the manifold 5 is disposed so as to correspond to the opening 22, on the other surface, the head chip 1 is disposed so as to correspond to the opening 22. That is, the wiring board 2 communicates the manifold 5 and the head chip 1 through the opening 22. The lower end of the manifold 5 is fixed to the outer edge of the wiring board 2.

A flexible substrate 3 electrically connects the electrode portion of the driving circuit board 4 and the wiring board 2. Thus, the signal from the drive circuit board 4 is adapted to be applied to the driving electrode provided in the partition wall (not shown) in the head chip 1 via the flexible substrate 3.

The manifold 5 is disposed on the head tip 1 via the wiring board 2 and communicates with the pressure chamber 131 of the head chip 1 via the wiring board 2 (see FIG. 5). The manifold 5 has a hollow main body portion 52 constituting a common ink chamber 51 (ink chamber), first to fourth ink ports 53 to 56 constituting an ink flow path, and a discharge liquid chamber 57.

The common ink chamber 51 has a filter F therein for removing foreign matters in the ink. Thus, the common ink chamber 51 is partitioned into a first liquid chamber 51a and a second liquid chamber 51b. The common ink chamber 51 stores the ink to be introduced into the pressure chamber 131.

The first ink port 53 is in communication with the first liquid chamber 51a and is used for introducing the ink into the common ink chamber 51. That is, the first ink port 53 functions as an inlet for introducing the ink into the inkjet head 100. A first joint 81a is inserted into the tip portion of the first ink port 53.

The second ink port 54 is in communication with the first liquid chamber 51a and is used for removing bubbles in the first liquid chamber 51a. A second joint 81b is inserted into the tip portion of the second ink port 54.

The third ink port 55 is in communication with the second liquid chamber 51b and is used for removing bubbles in the second liquid chamber 51b. A third joint 82a is inserted into the tip portion of the third ink port 55.

The fourth ink port 56 is in communication with the discharge liquid chamber 57 of the head chip 1. The ink discharged from the head chip 1 through the fourth ink port 56 is discharged to the outside of the inkjet head 100 through the fourth ink port 56. That is, the fourth ink port 56 functions as an outlet for discharging ink to the outside of the inkjet head 100.

The discharge liquid chamber 57 is arranged between the head chip 1 and the fourth ink port 56, and connects them.

The housing 6 is formed so as to accommodate the head chip 1 and the wiring board 2, the flexible substrate 3, and the manifold 5 inside thereof (see FIG. 4). A bottom surface of the housing 6 is open. Further, both end portions in the X direction of the housing 6, mounting holes 68 for attaching the housing 6 to the printer body side are respectively formed.

A cap receiving plate 7 has a nozzle opening 71 substantially in the center. The cap receiving plate 7 is attached so as to close the bottom opening of the housing 6 while exposing the nozzle substrate 11 through the nozzle opening 71.

The cover member 9 is attached to the housing 6 as shown in FIG. 3.

(Operation of Inkjet Head 100)

The ink is introduced from the first ink port 53 into the first liquid chamber 51a of the common ink chamber 51. The introduced ink passes through the second liquid chamber 51b via the filter F and is introduced into the inlet of the pressure chamber 131.

When a voltage is applied to the drive electrodes provided in the partition wall, the partition wall is displaced and pressure is applied to the ink introduced in the pressure chamber 131. By the generation of such a pressure, the ink in the pressure chamber 131 is ejected from the tip (discharge port) of the nozzle 111 toward the fabric 240.

In the inkjet head 100 of FIG. 3 to FIG. 5, an example in which the ejection method is the piezo method is shown, but the present invention is not limited to this, and a thermal method may be used.

The printing method of the printing device 200 is not particularly limited, and may be a single pass method or a scanning method. In terms of being effective for high-speed printing, the single-pass method is preferable. As the image forming apparatus of the single pass system, it is preferable to use an inkjet head of the line head system.

<Drying-Fixing Device>

As shown in FIG. 1, the drying device in the drying-fixing device 500 is a device which dries the aqueous ink 110 given to the fabric 240 by the aforementioned printing device 200, and removes the moisture and the solvent component in the ink. The fixing device is a device which, after drying, further fixes the aqueous ink 110 on the fabric 240 by heating, and thereby, the original hue of the ink may be developed.

The drying device is not particularly limited, and may be a method using a heater, a hot air dryer, or a heating roller. Among them, it is preferable that both surfaces of the fabric be heated and dried using a hot air dryer and a heater.

As the fixing device, for example, a heat treatment device by an atmospheric pressure steam method, a high pressure steam method, or a thermofix method may be cited.

[Aqueous Ink]

It is preferable that the aqueous ink used in the inkjet printing apparatus of the present invention contains a colorant, water, a water-soluble organic solvent, and a hydrophobic polymer. Then, it is preferable that the viscosity at 25° C. of the aqueous ink is adjusted to a range of 6 to 20 cp.

When the viscosity of the ink is 6 cp or more, even if the ink is ejected at a high ejection frequency by using the inkjet head 100, the meniscus of the ink in the vicinity of the ejection port of the nozzle 111 is unlikely to become unstable, so that the decrease in ejection stability may be suppressed. When the viscosity of the ink is 20 cp or less, since the viscosity of the ink is not too high, nozzle clogging may be suppressed. From a similar viewpoint, the viscosity of the ink is more preferably within a range of 7 to 15 cp.

The viscosity of the ink may be measured by an E-type viscometer at 25° C. The number of revolutions may be set according to the viscosity, but may be, for example, 10 rpm or 20 rpm.

The viscosity of the ink may be adjusted by an ink composition, for example, a content of a colorant, a content of a hydrophobic polymer, and a solvent composition. From the viewpoint of moderately increasing the viscosity of the ink, it is preferable to set the content of the colorant to be equal to or higher than a certain value, or to set the content of a polyhydric alcohol containing an alcohol having a high viscosity, e.g., 3 or more valences such as glycerin, as a water-soluble organic solvent, or to set the content of the hydrophobic polymer to be equal to or higher than a certain value, and it is more preferable to combine 2 or more of these.

The colorant is not particularly limited, and is preferably a pigment or a dye, for example.

<Pigment>

The pigment is not particularly limited, but may be, for example, an organic pigment or an inorganic pigment having the following numbers listed in the color index.

Examples of a red or magenta pigment include:

C.I. Pigment Red 3, 5, 19, 22, 38, 43, 48:2, 48:3, 48:4, 49:1, 53:1, 57:2, 58:4, 63:1, 81:2, 81:3, 88, 104, 108, 123, 144, 146, 149, 166, 168, 169, 170, 71, 178, 184, 185, 208, 216, 226, and 257;

C.I. Pigment Violet 3, 19, 23, 29, 30, 37, 50, and 88; and

C.I. Pigment Orange 13, 16, 20, and 36.

Examples of a blue or cyan pigment include:

C.I. Pigment Blue 1, 15, 15:1, 15:2, 15:3, 15:4, 15:6, 16, 17-1, 22, 27, 28, 29, 36, and 60.

Examples of a green pigment include:

C.I. Pigment Green 7, 26, 36, and 50.

Examples of a yellow pigment include:

C.I. Pigment Yellow 1, 3, 12, 13, 14, 17, 34, 35, 37, 55, 74, 81, 83, 93, 94, 95, 97, 108, 109, 110, 137, 138, 139, 153, 154, 155, 157, 166, 167, 168, 180, 185, and 193.

Examples of a black pigment include:

C.I. Pigment Black 7, 28, and 26.

Examples of a commercially available pigment are as follows. Chromofine Yellow 2080, 5900, 5930, AF-1300, 2700L, Chromofine Orange 3700L, 6730, Chromofine Scarlet 6750, Chromofine Magenta 6880, 6866, 6891N, 6790, 6887, Chromofine Violet RE, Chromofine Red 6820, 6830, Chromofine Blue HS-3, 5187, 5108, 5197, 5085N, SR-5020, 5026, 5050, 4920, 4927, 4937, 4824, 4933GN-EP, 4940, 4973, 5205, 5208, 5214, 5221, 5000P, Chromo Fine Green 2GN, 2G0, 2G-550D, 5310, 5370, 6830, Chromofine Black A-1103, Seika Fast Yellow 10GH, A-3, 2035, 2054, 2200, 2270, 2300, 2400 (B), 2500, 2600, ZAY-260, 2700 (B), 2770, Seika Fast Red 8040, C405 (F), CA120, LR-116, 1531B, 8060R, 1547, ZAW-262, 1537B, GY, 4R-4016, 3820, 3891, ZA-215, Seika Fast Carmin 6B1476T-7, 1843LT, 3840, 3870, Seika Fast Bordeaux 10B-430, Seika Light Rose R40, Seika Light Violet B800, 7805, Seika Fast Maroon 460N, Seika Fast Orange 900, 2900, Seika Light Blue C718, A612, Cyanine Blue 4933M, 4933GN-EP, 4940, 4973 (manufactured by Dainichiseika Color & Chemicals Mfg. Co., Ltd.); KET Yellow 401, 402, 403, 404, 405, 406, 416, 424, KET Orange 501, KET Red 301, 302, 303, 304, 305, 306, 307, 308, 309, 310, 336, 337, 338, 346, KET Blue 101, 102, 103, 104, 105, 106, 111, 118, 124, KET Green 201 (manufactured by DIC Corporation); Colortex Yellow 301, 314, 315, 316, P-624, 314, U10GN, U3GN, UNN, UA-414, U263, Finecol Yellow T-13, T-05, Pigment Yellow 1705, Colortex Orange 202, Colortex Red101, 103, 115, 116, D3B, P-625, 102, H-1024, 105C, UFN, UCN, UBN, U3BN, URN, UGN, UG276, U456, U457, Colortex Maroon 601, Colortex Brown B610N, Colortex Violet 600, Pigment Red 122, Colortex Blue 516, 517, 518, 519, A818, P-908,510, Colortex Green 402, 403, Colortex Black 702, U905 (manufactured by Sanyo Color Works, Ltd.); Lionol Yellow 1405G, Lionol Blue FG7330, FG7350, FG7400G, FG7405G, ES, ESP-S (manufactured by Toyo Ink Co., Ltd.); Toner Magenta E02, Permanent Rubin F6B, Toner Yellow HG, Permanent Yellow GG-02, Hostapeam Blue B2G (manufactured by Hoechst Industry); Novoperm P-HG, Hostaperm Pink E, Hostaperm Blue B2G (manufactured by Clamant Ltd.); Carbon Blacks #2600, #2400, #2350, #2200, #1000, #990, #980, #970, #960, #950, #850, MCF88, #750, #650, MA600, MA7, MA8, MA11, MA100, MA100R, MA77, #52, #50, #47, #45, #45L, #40, #33, #32, #30, #25, #20, #10, #5, #44, and CF9 (manufactured by Mitsubishi Chemical Corporation).

<Dye>

The dye is not particularly limited, and examples thereof include a disperse dye, a reactive dye, an acid dye, a basic dye, and a direct dye. Note that an ink containing a disperse dye is referred to as a disperse ink, and an ink containing a reactive dye is also referred to as a reactive ink.

As the disperse dye, a sublimable dye is preferred. Here, the “sublimable dye” refers to a dye having a property of sublimating by heating.

The disperse dye is not particularly limited, and examples thereof are as follows:

C.I. Disperse Yellow 3, 4, 5, 7, 9, 13, 23, 24, 30, 33, 34, 42, 44, 49, 50, 51, 54, 56, 58, 60, 63, 64, 66, 68, 71, 74, 76, 79, 82, 83, 85, 86, 88, 90, 91, 93, 98, 99, 100, 104, 108, 114, 116, 118, 119, 122, 122, 126, 135, 140, 141, 149, 160, 162, 163, 164, 165, 179, 180, 182, 183, 184, 186, 192, 198, 199, 202, 2004, 210, 211, 215, 216, 228, 24 231, and 232;

C.I. Disperse Orange 1, 3, 5, 13, 5, 13, 17, 20, 25, 29, 30, 31, 32, 33, 37, 38, 42, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, and 142;

C.I. Dispersed Red 1, 4, 5, 11, 7, 12, 17, 43, 50, 52, 45, 54, 55, 56, 58, 59, 60, 65, 73, 74, 75, 76, 78, 82, 88, 90, 91, 92, 93, 103, 105, 108, 110, 111, 113, 117, 118, 121, 122, 126, 127, 132, 134, 135, 143, 145, 151, 152, 153, 154, 157, 164, 167, 179, 181, 184, 185, 189, 190, 191, 200, 201, 202, 205, 206, 207, 210, 221, 224, 225, 227, 229, 240, 257, 258, 277, 278, 281, 288, 302, 303, 310, 311, 312, 320, 324, and 328;

C.I. Disperse Violet 1, 4, 8, 23, 26, 27, 28, 31, 33, 35, 36, 38, 40, 43, 46, 48, 50, 51, 52, 56, 57, 59, 61, 63, 69, and 77;

C.I. Disperse Green 9;

C.I. Disperse Brown 1, 2, 4, 9, 13, and 19;

C.I. Disperse Blue 3, 7, 9, 16, 20, 27, 43, 45, 55, 56, 58, 60, 62, 64, 71, 72, 73, 75, 81, 82, 83, 91, 94, 95, 102, 106, 113, 115, 120, 125, 128, 130, 139, 141, 142, 143, 46, 148, 153, 158, 167, 171, 174, 176, 181, 183, 185, 186, 187, 189, 197, 200, 201, 205, 211, 224, 225, 257, 268, 270, 285, 287, 291, 293, 295, 297, 30, 315, 333, 359, and 360; and

C.I. Disperse Black 1, 3, 10, and 24.

The acid dye is not particularly limited, and examples thereof are as follows:

C.I. Acid Yellow 1, 3, 6, 11, 17, 18, 19, 23, 25, 36, 38, 40, 40:1, 42, 44, 49, 59, 59:1, 61, 65, 67, 72, 73, 79, 99, 104, 159, 169, 176, 184, 193, 200, 204, 207, 215, 219, 219:1, 220, 230, 232, 235, 241, 242, and 246;

C.I. Acid Orange 3, 7, 8, 10, 19, 22, 24, 33, 51, 51S, 56, 67, 74, 1487, 1487, 1487 156, 162, 166, and 168;

C.I. Acid red 1, 6, 8, 9, 13, 18, 27, 35, 37, 52, 54, 57, 60, 73, 82, 88, 97, 97:1, 106, 111, 114, 118, 119, 127, 131, 138, 143, 145, 151, 183, 195, 198, 211, 215, 217, 225, 226, 249, 251, 254, 256, 257, 289, 296, 315, 318, 336, 337, 357, 361, 362, 364, 369, 399, 407, 415 and 126;

C.I. Acid Blue 1, 7, 9, 15, 23, 25, 40, 61:1, 62, 72, 74, 80, 83, 90, 92, 103, 104, 112, 113, 114, 120, 127, 127:1, 128, 129, 138, 140, 142, 156, 158, 171, 182, 185, 193, 199, 201, 203, 204, 205, 207, 209, 220, 221, 224, 225, 229, 230, 239, 258, 260, 264, 277:1, 278, 279, 280, 284, 290, 296, 298, 300, 317, 324, 333 104, 108, and 109;

C.I. Acid Brown 2, 4, 13, 14, 19, 28, 44, 123, 224, 226, 227, 248, 282, 283, 289, 294, 297, 298, 301, 355, 357, and 413; and

C.I. Acid Black 1, 2, 3, 24, 24:1, 26, 31, 50, 52, 52:1, 58, 60, 63, 63S, 107, 109, 112, 119, 132, 140, 155, 172, 187, 188, 194, 207, and 222.

The basic dye is not particularly limited, and examples thereof are as follows:

C.I. Basic Yellow 1, 2, 13, 19, 21, 25, 32, 36, 40, and 51;

C.I. Basic Red 1, 5, 12, 19, 22, 29, 37, 39, 92; C.I. Basic Blue 1, 3, 9, 11, 16, 17, 24, 28, 41, 45, 54, 65, and 66; and

C.I. Basic Black 2, and 8.

The direct dye is not particularly limited, and examples thereof are as follows:

C.I. Direct Yellow 8, 9, 10, 12, 27, 28, 39, 44, 50, 86, 87, 98, 105, 106, 130, 137, 142, and 153;

C.I. Direct Orange 6, 26, 27, 34, 40, 46, 105, 107, and 118;

C.I. Direct Red 2, 4, 9, 23, 24, 31, 54, 6, 62, 98, 83, 84, 89, 95, 212, 224, 225, 227, 239, 242, and 254;

C.I. Direct Violet 9, 35, 51, 66, 94, and 95;

C.I. Direct Blue 1, 15, 76, 77, 80, 86, 87, 90, 106, 108, 160, 89, 192, 193, 200, 201, 202, 218, 229, 237, 244, 251, 270, 274, 290, and 291;

C.I. Direct Green 26, 28, 59, 80, and 85;

C.I. Direct Brown 4, 4: 1, 106, 195, 210, 212, 22, and 223; and

C.I. Direct Black 17, 19, 22, 32, 51, 62, 108, 113, 117, 118, 132, 146, 154, 159, and 169.

The reactive dye is not particularly limited, and examples thereof are as follows:

C.I. Reactive Yellow 2, 3, 7, 15, 23, 24, 25, 27, 37, 39, 42, 57, 69, 81, 84, 85, 86, 92, 95, 102, 125, 135, 136, 142, 143, 151, 160, 161, 165, 167, 168, 175, and 76;

C.I. Reactive Orange 1, 4, 5, 12, 13, 15, 16, 20, 30, 35, 56, 64, 67, 70, 72, 74, 82, 84, 87, 91, 92, 93, 95, 99, and 107;

C.I. Reactive Red 2, 3, 1, 5, 8, 12, 23, 28, 29, 33, 35, 43, 45, 49, 55, 56, 58, 66, 78, 83, 106, 111, 112, 14, 116, 120, 124, 128, 130, 141, 147, 158, 171, 174, 180, 183, 184, 187, 190, 194, 195, 218, 220, 223, 226, 228, 235, and 245;

C.I. Reactive Violet 1, 2, 4, 5, 6, 22, 23, 36, and 38;

C.I. Reactive Blue 2, 3, 4, 7, 13, 4, 15, 27, 28, 29, 38, 39, 41, 50, 52, 63, 69, 71, 77, 89, 104, 109, 112, 14, 116, 119, 120, 137, 140, 147, 160, 162, 163, 168, 171, 176, 182, 184, 191, 194, 203, 207, 209, 214, 221, 222, 231, 235, and 236;

C.I. Reactive Green 8, 12, 19, and 21;

C.I. Reactive Brown 2, 7, 9, 10, 11, 17, 18, 23, 31, 43, and 46; and

C.I. Reactive Black 5, 8, 13, 14, 31, 34, and 39.

The dyes described above may be used alone, or 2 or more kinds thereof may be used in combination.

Of these, pigments are preferred because they have good dispersibility with respect to the constituent components of the ink and are excellent in weather resistance.

The content of the colorant is not particularly limited, but is preferably within a range of 4 to 15% by mass based on the ink from the viewpoint of easily adjusting the viscosity of the ink within the above range and allowing a high density image to be formed. When the content of the colorant is 4% by mass or more, not only the viscosity of the ink may be moderately increased but also a high density image may be easily formed. When the content of the colorant is 15% by mass or less, since the viscosity of the ink does not become too high, nozzle clogging hardly occurs. From the same viewpoint, the content of the colorant is more preferably within a range of 5 to 15% by mass, and still more preferably within a range of 6.5 to 12% by mass, based on the ink.

<Hydrophobic Polymer>

The hydrophobic polymer is a water-dispersible polymer, and may be a polymer dispersant, or a water-dispersible resin (binder resin).

(Polymer Dispersant)

The type of the polymer dispersant is not particularly limited, and examples thereof include block copolymers random copolymers and salts thereof composed of 2 or more kinds of monomers selected from styrene, styrene derivative, vinylnaphthalene derivative, acrylic acid, acrylic acid derivative, maleic acid, maleic acid derivative, itaconic acid, itaconic acid derivative, fumaric acid, and fumaric acid derivative; polyoxyalkylene; and polyoxyalkylene alkyl ethers.

When the polymer dispersant has an acidic group such as a carboxy group, the acidic group is preferably neutralized with a neutralizing base. Examples of neutralizing bases include organic bases such as ammonia, monoethanolamine, diethanolamine, triethanolamine, and morpholine.

(Water-Dispersible Resin)

Examples of the water-dispersible resin include urethane-based resins, butadiene-based resins, acrylic resins, and polystyrene. Examples of the butadiene-based resin include a styrene-butadiene copolymer and an acrylonitrile-butadiene copolymer. Examples of the acrylic resin include acrylic ester copolymers, styrene-acrylic copolymers, silicon-acrylic copolymers, and acrylic modified fluorine resins. Among them, a urethane-based resin or a styrene-acrylic copolymer is preferred.

Examples of the styrene-acrylic copolymer include a styrene-(metha)acrylic acid copolymer and a styrene-(metha)acrylic acid-(metha)acrylic estercopolymer. Examples of the (meth)acrylate include benzyl (meth)acrylate, cyclohexyl (meth)acrylate, methyl (meth)acrylate, propyl (meth)acrylate, butyl (meth)acrylate, hexyl (meth)acrylate, octyl (meth)acrylate, lauryl (meth)acrylate, 2-ethylhexyl (meth)acrylate, 2-ethylhexyl carbitol (meth)acrylate, phenol EO modified (meth)acrylate, isobornyl (meth)acrylate, dicyclopentenyl (meth)acrylate, dicyclopentanyl (meth)acrylate, and dicyclopentenyloxyethyl (meth)acrylate.

The urethane resin is a polymer obtained by reacting a polyol with a polyisocyanate. Examples of the polyol include polypropylene glycol, polyethylene glycol, polytetramethylene glycol, poly(ethylene adipate), poly(diethylene adipate), poly(propylene adipate), poly(tetramethylene adipate), poly(hexamethylene adipate), poly-ε-caprolactone, poly(hexamethylene carbonate), and silicone polyol. Examples of the isocyanate include tolylene diisocyanate, 4,4-diphenylmethane diisocyanate, xylylene diisocyanate, naphthalene diisocyanate, hexamethylene diisocyanate, hydrogenated tolylene diisocyanate, hydrogenated 4,4-diphenylmethane diisocyanate, isophorone diisocyanate, and tetramethylxylylene diisocyanate.

The Tg of the water-dispersible resin is not particularly limited, but it is for example within a range of −30 to 100° C., preferably −10 to 50° C., and more preferably 20 to 40° C.

The acid value of the water-dispersible resin is not particularly limited, but is preferably 44 mg KOH/g or more, and more preferably 60 mg KOH/g or more, from the viewpoint of enhancing dispersion stability. The upper limit value of the acid value may be, for example, 110 mg KOH/g. The acid value may be measured according to JIS K0070.

The average particle diameter of the water-dispersible resin is not particularly limited, but is preferably 300 nm or less, and more preferably 130 nm or less from the viewpoint of preventing nozzle clogging of the inkjet head. The average particle diameter of the water-dispersible resin may be measured by laser diffraction scattering particle diameter distribution measurement.

The content of the hydrophobic polymer is appropriately set according to the type thereof. For example, when the hydrophobic polymer is a polymer dispersant, the content of the polymer dispersant is preferably within a range of, for example, 4% by mass or less, preferably 0.8 to 2% by mass, based on the ink. When the polymer dispersant is 0.8% by mass or more, dispersibility of a solid colorant such as a pigment is easily sufficiently increased, and when it is 4% by mass or less, excessive increase in viscosity is easily suppressed.

When the hydrophobic polymer is a water-dispersible resin (binder resin), the content of the water-dispersible resin (binder resin) is preferably 1 to 15% by mass based on the ink from the viewpoint of easily adjusting the viscosity of the ink within the above range. When the content of the water-dispersible resin is 1% by mass or more, since the viscosity of the ink is easily increased moderately, not only the injection stability may be further increased but also the adhesion and scratch resistance of the obtained image to the fabric may be easily increased. When the content of the water-dispersible resin is 15% by mass or less, since the viscosity of the ink does not become too high, nozzle clogging hardly occurs. From the same viewpoint, the content of the water-dispersible resin is more preferably 2 to 10% by mass based on the ink.

When the hydrophobic polymer contains both a polymer dispersant and a water-dispersible resin, the total amount of the hydrophobic polymer is preferably 1 to 20% by mass, and preferably 2 to 15% by mass, based on the ink, from the viewpoint of easily adjusting the viscosity of the ink to the above range.

<Water-Soluble Organic Solvent>

The water-soluble organic solvent is not particularly limited as long as it is compatible with water, and examples thereof include polyhydric alcohols (e.g., 2 valent alcohols such as ethylene glycol, diethylene glycol, polyethylene glycol, propylene glycol, tripropylene glycol, and polypropylene glycol, and alcohols having 3 or more valences such as glycerin, trimethylolpropane, and hexanetriol); polyhydric alcohol ethers (e.g., ethylene glycol monomethyl ether, ethylene glycol monobutyl ether, ethylene glycol monophenyl ether, diethylene glycol monomethyl ether, diethylene glycol monoethyl ether,diethylene glycol monobutyl ether, diethylene glycol dimethyl ether, propylene glycol monomethyl ether, Propylene glycol monoethyl ether); monohydric alcohols (e.g., methanol, ethanol, pentanol, hexanol, cyclohexanol, benzyl alcohol); amines (e.g., ethanolamine, N-ethyldiethanolamine, ethylenediamine, triethylenetetramine); amides (e.g., formamide, N,N-dimethylformamide, N,N-dimethylacetamide); heterocycles (e.g., 2-pyrrolidone, N-methyl-2-pyrrolidone, include N-cyclohexyl-2-pyrrolidone, 2-oxazolidone, 1,3-dimethyl-2-imidazolidine), sulfoxides (e.g., dimethyl sulfoxide); and sulfones (e.g., sulfolanes).

Among them, from the viewpoint of moderately increasing the viscosity of the ink, the water-soluble organic solvent preferably contains a polyhydric alcohol. From the viewpoint of easily increasing the viscosity of the ink, the polyhydric alcohols preferably contain alcohols having 3 or more valences, and more preferably contain glycerin.

The content of the polyhydric alcohols is preferably moderately large. Specifically, it is preferable that the content of the polyhydric alcohol is within a range of 25 to 50% by mass based on the ink. When the content of the polyhydric alcohol is equal to or higher than a certain value, the viscosity of the ink is easily increased, and when the content is below a certain level, it is easy to suppress nozzle clogging due to the viscosity of the ink becoming too high. From a similar viewpoint, the content of the polyhydric alcohol is more preferably within a range of 30 to 45% by mass based on the ink.

<Other Ingredient>

The inkjet ink may further comprise other components if necessary. Examples of other components include solvents, surfactants, preservatives, mold inhibitors, rust inhibitors, and pH adjusters.

(Surfactant)

The aqueous inkjet ink may further include a surfactant to control its surface tension.

Examples of the surfactant include anionic, cationic, amphoteric, and nonionic systems. Examples of the anionic surfactant include fatty acid salts, alkyl sulfates, alkyl sulfate esters, alkyl benzene sulfonates, alkyl naphthalene sulfonates, dialkyl sulfosuccinates, alkyl phosphate esters, alkyl naphthalene sulfonate formalin condensates, and polyoxyethylene alkyl sulfates. Examples of the cationic surfactant include amine salts, tetraalkyl quaternary ammonium salts, trialkyl quaternary ammonium salts, alkylpyridinium salts, and alkylquinolinium salts. Examples of the nonionic surfactant include polyoxyethylene alkyl ether, polyoxyethylene alkylphenyl ether, polyoxyethylene fatty acid ester, polyoxyethylene sorbitan fatty acid ester, polyoxyethylene alkylamine, ethylene oxide adducts of polypropylene glycol, ethylene glycol, and ethylene oxide adducts of acetylene glycol.

(Preservative and Fungicide)

Examples of the preservative and fungicide include aromatic halogen compounds (e.g., Preventol CMK), methylene dithiocyanate, halogen-containing nitrogen-sulfur compounds, and 1,2-benzisothiazoline-3-one (e.g., PROXEL GXL).

(pH Adjuster)

Examples of the pH adjuster include urea and sodium hydroxide.

[Printing Method]

In the printing method using the inkjet printing apparatus of the present invention, after or when the aqueous ink is ejected onto the fabric, the aqueous ink is dried and fixed on the fabric by a heat treatment such as a heat press to form an image, and then an image is formed. Then a cleaning liquid is applied to the fabric to clean the fabric, and the cleaning liquid after cleaning is removed. In addition, when the disperse dye contained in the aqueous ink is a sublimable dye having a property of sublimating by heating, a sublimation transfer is also included as a textile printing method according to the present invention. Examples of the printing method using such sublimation transfer include a method (sublimation transfer method) in which an aqueous ink containing a sublimation dye (also referred to as sublimation transfer ink) is used for an intermediate transfer medium in a sheet form such as paper, and then printing is performed by an inkjet method, and then an intermediate transfer medium is superposed on the fabric and sublimation transfer is performed by heating. Further, even when the disperse dye contained in the aqueous ink is a sublimable dye, a method (also referred to as a direct sublimation method) in which printing is directly performed on a fabric by an inkjet method without using an intermediate transfer medium may be used. In the following description, a printing method that does not use sublimation transfer will be described as an example.

The above-mentioned printing method ejects the aqueous ink described above from the inkjet head 100 of the printing device 200 in the inkjet printing apparatus 800 of FIG. 1 to form an image 120 on the fabric 240, and thereafter, the fabric 240 is washed by the cleaning liquid 310, and then the washing liquid 310 after washing is removed.

Specifically, the printing method according to the present invention includes the following steps: (1) a step of ejecting an ink from the inkjet head 1 to impart (adhere) droplets of the aqueous ink on a fabric (ink application step), (2) a step of drying and fixing the aqueous ink imparted to the fabric (drying and fixing step), (3) a step of applying a cleaning liquid to the fabric (cleaning liquid coating step), and (4) a step of removing the cleaning liquid by washing (cleaning liquid removing step).

Step (1) (Ink Application Step)

In the ink application step, at least the above-described aqueous ink is ejected from the inkjet head 100 of the printing device 200 of FIG. 1 to apply ink onto the fabric 240.

The discharge frequency by the inkjet head is preferably in the range of 20 to 50 kHz in terms of enabling high-speed printing.

In the present invention, as described above, the ink is ejected from the inkjet head 100 of the printing device 200 of FIG. 1. The surface of the fabric to which the ink is imparted may be heated. Thereby, it is possible to increase the drying rate after the ink is applied, and it is possible to easily suppress bleeding of the image. The surface temperature of the fabric when the ink is applied is preferably within a range of 35 to 70° C.

The heating method is not particularly limited, but may be heated from a surface of the fabric opposite the surface to which the ink is applied. The heating means is not particularly limited, it may be any of an infrared heater, a heating wire, a UV lamp, a gas, and a hot air dryer. Among them, heating by a heating wire and an infrared heater is preferable in terms of safety and energy efficiency.

Step (2) (Drying and Fixing Step)

In the drying and fixing step, as shown in FIG. 1, the ink imparted to the fabric 240 is dried using the drying-fixing device 500 to remove moisture and solvent components in the ink, and further, the ink is fixed on the fabric by heating. Thus, it is possible to develop the original hue of the ink.

The drying method is not particularly limited, and it may be a method using a heater, a hot air dryer, or a heating roller. Among them, it is preferable that both surfaces of the fabric be heated and dried using a hot air dryer and a heater.

When drying is performed using a heating means such as a heater, the heating means may be disposed on the downstream side of the inkjet head in the conveying direction of the fabric for drying, it may be disposed on the upstream side of the inkjet head in the conveying direction of the fabric for drying the ink by heat accumulated in the fabric before the inkjet head ejects the ink, or it may be disposed on both the upstream side and the downstream side of the inkjet head in the conveying direction of the fabric for drying.

The drying temperature is not particularly limited, but it may be, for example, 160° C. or less. The drying time may be, for example, about 0.5 to 30 minutes, although it depends on the drying temperature.

As a means for heating to develop the original hue of the ink, for example, heat treatment by an atmospheric pressure steam method, a high pressure steam method, or a thermofix method may be cited. The temperature at the time of heat treatment is preferably 120 to 200° C., more preferably within a range of 140 to 180° C.

Step (3) (Cleaning Liquid Coating Step)

In the step of applying the cleaning liquid, the cleaning liquid 310 is applied to the fabric 240 to which the ink is applied and dried and fixed by the coating device 300 shown in FIG. 1. By applying the cleaning liquid 310, a colorant, a preservative, a solvent, and a surfactant, which cannot be adhered to the fabric 240 and remain, are dissolved in the cleaning liquid.

Step (4) (Cleaning Liquid Removing Step)

In the removing step of the cleaning liquid, the cleaning liquid 310 in which the colorant, the preservative, the solvent, and the surfactant are dissolved in the coating step (3) is removed by the removing device 400 shown in FIG. 1.

The printing method in the present invention may further have other steps other than those described above depending on the type of the aqueous ink. For example, prior to the step of (1), a step (1-a) of imparting a pretreatment agent to the fabric (pretreatment step) may be performed, or after the step of removing the cleaning liquid of step (4), a step (5) of drying the washed fabric 240 (drying step) may be performed.

Step (1-a) (Pretreatment Step)

In the pretreatment step, from the viewpoint of preventing bleeding of the ink or improving fixability, an image may be formed on a fabric pretreated by a pretreatment agent containing water, a polyvalent metal ion, or a polymer, if necessary. The pretreatment may be performed by an off-line process in which image formation is performed on a fabric to which a pretreatment agent is imparted, or may be performed by an in-line process in which pretreatment is continuously performed with image formation. The method of imparting the pretreatment agent is not particularly limited, and may be an inkjet method or a coating method using a coater. As the pretreatment agent, for example, the pretreatment agent described in JP-A 2019-073642 may be used.

Step (5) (Drying Step)

The drying step is performed after the cleaning liquid removing step (4), and the washed fabric is dried in this step. The drying method is not particularly limited, but may be a method in which a washed fabric is squeezed, dried, or dried using a dryer (heat roll or iron).

### EXAMPLES

Hereinafter, the present invention will be specifically described with reference to Examples, but the present invention is not limited thereto. In the following examples, unless otherwise specified, the operation was carried out at room temperature (25° C.). Also, unless otherwise specified, “%” and “parts” mean “% by mass” and “parts by mass”, respectively.

[Ink Components]

<Reactive Dye>

C.I. Reactive Red 24

<Disperse Dye>

C.I. Disperse Red 152

<Sublimation Dye>

C.I. Disperse Red 60

<Pigment>

Pigment Red 122

<Hydrophobic Polymer>

(Polymer Dispersant)

J819 (Joncryl818, manufactured BASF Japan Co., Ltd., Tg: 57° C., acid value: 75 mg KOH/g, ammonia-neutralized)

(Water-Dispersible Resin)

WBR-2000U (Aciylite, manufactured by Taisei Fine Chemical Co., Ltd., polyurethane resin particles, Tg: 45° C.)

<Water-Soluble Organic Solvents>

Ethylene glycol

Glycerin

Propylene glycol

<Surfactant>

KF351A (polyoxyethylene-modified silicone, manufactured by Shin-Etsu Silicone Co., Ltd.).

<Preservative>

PROXEL GXL (1,2-benzisothiazoline-3-one)

[Preparation of Inks 1 to 4]

Inks 1 to 4 were prepared by mixing each component so as to have the composition shown in Table I below.

TABLE 1

| | | | | | | Water- | | | | | | | | | | | | |
|---|---|---|---|---|---|---|---|---|---|---|---|---|---|---|---|---|---|---|
| | | | | Polymer | | dispersible | | Water-soluble organic | | | | | | Surfac- | | Preser- | | Wa- |
| Ink | Colorant | | | dispersant | | resin | | solvent | | | | | | tant | | vative | | ter |
| No. | Type | | *1 | Type | *1 | Type | *1 | Type | *1 | Type | *1 | Type | *1 | Type | *1 | Type | *1 | *1 |
| 1 | C.I. | Reactive | 10 | — | 0 | — | 0 | Ethylene | 20 | Glyc- | 10 | Propylene | 10 | KF351A | 0.1 | PROXEL | 0.5 | 49.4 |
| | Reactive | dye | | | | | | glycol | | erin | | glycol | | | | GXL | | |
| | Red 24 | | | | | | | | | | | | | | | | | |
| 2 | C.I. | Disperse | 7.5 | J819 | 2.5 | — | 0 | Ethylene | 20 | Glyc- | 10 | Propylene | 10 | KF351A | 0.1 | PROXEL | 0.5 | 49.4 |
| | Disperse | dye | | | | | | glycol | | erin | | glycol | | | | GXL | | |
| | Red 152 | | | | | | | | | | | | | | | | | |
| 3 | Pigment | Pigment | 4.5 | J819 | 1.5 | WBR- | 5 | Ethylene | 20 | Glyc- | 10 | Propylene | 10 | KF351A | 0.1 | PROXEL | 0.5 | 48.4 |
| | Red122 | | | | | 2000U | | glycol | | erin | | glycol | | | | GXL | | |
| 4 | C.I. | Sub- | 7.5 | J819 | 2.5 | — | 0 | Ethylene | 20 | Glyc- | 10 | Propylene | 10 | KF351A | 0.1 | PROXEL | 0.5 | 49.4 |
| | Disperse | limable | | | | | | glycol | | erin | | glycol | | | | GXL | | |
| | Red 60 | dye | | | | | | | | | | | | | | | | |

*1: Content [parts by mass]

[Preparation of Cleaning Liquids a to C]

Cleaning liquids A to C were prepared according to the following composition.

Cleaning liquid A: 89.9% by mass of water, 10% by mass of ethanol, 0.1% by mass of surfactant (KF351A), and the pH (25° C.) was adjusted to 6.

Cleaning liquid B: the pH (25° C.) of the above cleaning liquid A was adjusted to 11 with sodium hydroxide and citric acid.

Cleaning liquid C: pure water

### Example 1

First, the inkjet printing apparatus shown in FIG. 1 was prepared. The configuration of the inkjet printing apparatus is as follows. Here, the printing system of the inkjet head in the printing apparatus was a scanning system, and Pro120 made by Konica Minolta Inc. was modified and used.
Coating device of cleaning liquid: Spray coating device
Application region of cleaning liquid to fabric: Full surface of fabric (including other than printing part)
Coating amount of cleaning liquid: 250 g/m²
Removing device of cleaning liquid: Suction device
Installation portion of coating device and removing device: One side of the printing surface of the fabric
Temperature of cleaning liquid: 25° C.
Reuse of cleaning liquid: None

[Fabric]

As a fabric, T/C broad (35% cotton, 65% polyester) was prepared.

[Printing]

The ink shown in Table II below was ejected from the nozzles of the inkjet head of the printing device to print the ink on the fabric. Specifically, printing was performed by the following procedure.

(1) Ink Application Step

The ink was set in a printing device. Then, at a main scan of 540 dpi×a sub scan of 720 dpi, an image was formed on the fabric using the obtained ink so as to have an average printing rate of 100%. Note that dpi represents the number of ink droplets (dots) per 2.54 cm. The discharge frequency was set to 22.4 kHz.

(2) Drying and Fixing Step

The fabric to which the ink was applied was dried in a belt conveying type dryer at 160° C. for 3 minutes to fix the ink.

(3) Cleaning Liquid Coating Step

Pure water was applied to the entire surface of one side of the printing surface of the fabric after the drying step using a spray coating device and washed. Here, the ink was applied and cleaned so as to have a coating amount of 50 g/m² in accordance with the average printing rate of the ink (average printing rate: 100%).

(4) Cleaning Liquid Removing Step

After the coating step of the cleaning liquid, the cleaning liquid remaining on the surface of the fabric was sucked using a suction device.

### Examples 2 to 8, and 11 to 18

In Example 1, the steps (1) to (4) above were performed in the same manner except that the types of the ink and the cleaning liquid, the coating device and the removing device for the cleaning liquid, the coating portion by the cleaning liquid, the coating amount, the installation location of the coating device and the removing device, and the temperature of the cleaning liquid were changed as shown in Table II below.

The following devices were used as a coating device and a removing device of the used cleaning liquid. The application amount of the cleaning liquid was controlled according to the printing rate of the inks, and the application amount was set to 50 g/m² when the printing rate exceeded 50%, the application amount was set to 20 g/m² when the printing rate was within 20 to 50%, and the application amount was set to 10 g/m² when the printing rate was less than 20%.

(Spray Coating Device)

Hole diameter of the tip of the nozzle: 1.4 mm

Compressed air pressure: 0.24 MPa

Distance from nozzle to fabric: 15 cm

(Mist Coating Device)

Hole diameter of the tip of the nozzle: 60 μm

Distance from nozzle to fabric: 5 cm

(Suction Device)

Negative pressure by suction pump: 3 MPa

(Blade Removing Device)

Blade material: Urethane resin

Shape of blade: Plate-shaped

Contact pressure: 20 N/m

(Air Blow Device)

Air pressure from nozzles: 3 MPa

### Example 9

Using the sublimation transfer ink prepared above, a transfer paper was printed as an intermediate transfer medium by an inkjet method using a printing device, and then the paper was placed on a fabric and heated to 180° C. to print on the paper. Thereafter, the above steps (1) to (4) were performed in the same manner as described above except that the type of the cleaning liquid, the coating device and removing device of the cleaning liquid, the coating portion by the cleaning liquid, the coating amount, the installation location of the coating device and removing device, and the temperature of the cleaning liquid were changed as shown in Table II below.

### Example 10

Using the sublimation transfer ink prepared above, it was printed directly on a fabric using a printing device without using an intermediate transfer medium as in Example 9. Thereafter, the above steps (1) to (4) were performed in the same manner except that the type of the cleaning liquid, the coating device and removing device of the cleaning liquid, the coating portion by the cleaning liquid, the coating amount, the installation location of the coating device and removing device, and the temperature of the cleaning liquid were changed as shown in Table II below.

### Comparative Example 1

The same procedure was carried out as in Example 1 except that in the steps of (3) and (4), a cleaning tank was used as a device for applying a cleaning liquid, and a fabric was passed through a cleaning tank, and further, a removing device for a cleaning liquid was not used.

### Comparative Example 2

The same procedure was carried out as in Example 5 except that the steps of (3) and (4) were not performed.

### Comparative Example 3

The same procedure was carried out as in Example 9 except that the steps of (3) and (4) were not performed.

[Evaluation]

<Amount of Discarded Cleaning Liquid>

The amount of cleaning liquid used and discarded was used as an evaluation criteria.

(Criteria)

AA: The amount of cleaning liquid used and discarded is less than 80 g/m².

BB: The amount of cleaning liquid used and discarded is 80 g/m² or more and less than 200 g/m².

CC: The amount of cleaning liquid used and discarded is 200 g/m² or more and less than 500 g/m².

DD: The amount of cleaning liquid used and discarded is 500 g/m² or more.

<Residual Amount of Colorant, Solvent, and Preservative>

Regarding the remaining amount of colorant, solvent and preservative remaining on the fabric after removing the cleaning liquid, ultrasonic cleaning was performed to extract the remaining amount. The average decrease rate of each substance obtained from the residual amount extraction when the washing step was not included was used as the evaluation criteria.

(Criteria)

AA: Less than 1/500 of the case in which cleaning was not performed

BB: 1/500 or more and less than 1/100 of the case in which cleaning was not performed

CC: 1/100 or more and less than 1/10 of the case in which cleaning was not performed

DD: 1/10 or more than the case in which cleaning was not performed

TABLE II

| | | | | | | | | | | | | Evaluation | |
|---|---|---|---|---|---|---|---|---|---|---|---|---|---|
| | | | Cleaning method | | | | | | | | | | Residual |
| | | | | Coating | | | Removing | | Temperature | | | Amount of | wnount of |
| | | | Cleaning | device of | | Coating | device of | | [° C.] of | pH of | Reuse of | Discarded | colorant, |
| | | | liquid | cleaning | Coating | Amount | cleaning | | Cleaning | cleaning | cleaning | Cleaning | solvent, and |
| | Ink No. | | No. | liquid | region | [g/m²] | liquid | *5 | liquid | liquid | liquid | liquid | preservative |
| *1-1 | 1 | Reactive | C | Spray | Full | 250 | Suction | *6 | 25 | 6 | None | CC | CC |
| | | ink | | coating | surface | | | | | | | | |
| *1-2 | 1 | Reactive | A | Spray | Full | 250 | Suction | *6 | 25 | 6 | None | CC | CC |
| | | ink | | coating | surface | | | | | | | | |
| *1-3 | 2 | Disperse | A | Spray | Full | 250 | Suction | *6 | 25 | 6 | None | CC | BB |
| | | ink | | coating | surface | | | | | | | | |
| *1-4 | 2 | Disperse | C | Spray | Full | 250 | Suction | *5 | 25 | 6 | None | CC | BB |
| | | ink | | coating | surface | | | | | | | | |
| *1-5 | 3 | Pigment | A | Spray | Full | 250 | Suction | *6 | 25 | 6 | None | CC | BB |
| | | ink | | coating | surface | | | | | | | | |
| *1-6 | 3 | Pigment | A | Spray | Full | 100 | Suction | *6 | 25 | 6 | None | BB | BB |
| | | ink | | coating | surface | | | | | | | | |
| *1-7 | 3 | Pigment | A | Spray | Full | 50 | Suction | *6 | 25 | 6 | None | AA | CC |
| | | ink | | coating | surface | | | | | | | | |
| *1-8 | 3 | Pigment | A | Spray | Full | 100 | Blade | *6 | 25 | 6 | None | BB | BB |
| | | ink | | coating | surface | | | | | | | | |
| *1-9 | 4 | *3 | A | Spray | Full | 100 | Blade | *6 | 25 | 6 | None | BB | BB |
| | | | | coating | surface | | | | | | | | |
| *1-10 | 4 | *3 | A | Spray | Full | 100 | Blade | *6 | 25 | 6 | None | BB | BB |
| | | (direct) | | coating | surface | | | | | | | | |
| *1-11 | 3 | Pigment | A | Spray | Full | 100 | Suction | *6 | 25 | 6 | None | BB | BB |
| | | ink | | coating | surface | | | | | | | | |
| *1-12 | 3 | Pigment | A | Spray | Full | 100 | Air blow | *6 | 25 | 6 | None | BB | BB |
| | | ink | | coating | surface | | | | | | | | |
| *1-13 | 3 | Pigment | A | Mist | Full | 100 | Suction | *5 | 25 | 6 | None | BB | BB |
| | | ink | | coating | surface | | | | | | | | |
| *1-14 | 3 | Pigment | A | Spray | *4 | 75 | Suction | *6 | 25 | 6 | None | AA | BB |
| | | ink | | coating | | | | | | | | | |
| *1-15 | 3 | Pigment | B | Spray | Full | 100 | Suction | *6 | 25 | 11 | None | BB | AA |
| | | ink | | coating | surface | | | | | | | | |
| *1-16 | 3 | Pigment | A | Mist | Full | 100 | Suction | *6 | 60 | 6 | None | BB | AA |
| | | ink | | coating | surface | | | | | | | | |
| *1-17 | 3 | Pigment | A | Spray | Full | 100 | Blade | *7 | 25 | 6 | None | BB | BB |
| | | ink | | coating | surface | | | | | | | | |
| *1-18 | 3 | Pigment | A | Spray | Full | 100 | Suction | *6 | 25 | 6 | Yes | AA | BB |
| | | ink | | coating | surface | | | | | | | | |
| *2-1 | 1 | Reactive | C | Cleaning | Full | — | — | *7 | 25 | 6 | None | DD | BB |
| | | ink | | tank | surface | | | | | | | | |
| *2-2 | 3 | Pigment | — | — | — | — | — | — | — | — | — | No | DD |
| | | ink | | | | | | | | | | cleaning | |
| *2-3 | 4 | *3 | — | — | — | — | — | — | — | — | — | No | DD |
| | | | | | | | | | | | | cleaning | |

*1: Example
*2: Comparative Example
*3: Sublimation transfer Ink
*4: Printing region only. Printing rate 50%
*5: Installation portion of coating device and removing device
*6: Printing surface
*7: Both surfaces

As shown in the above results, it can be seen that, by applying and removing the cleaning liquid using the inkjet printing apparatus of the present invention, the amount of waste water can be reduced, and further the colorant, the solvent and the preservative remaining in the fabric can be reliably removed as compared with the comparative example.

Although embodiments of the present invention have been described and illustrated in detail, the disclosed embodiments are made for purposes of illustration and example only and not limitation. The scope of the present invention should be interpreted by terms of the appended claims

What is claimed is:

1. An inkjet printing apparatus for printing an aqueous ink on a fabric comprising: a printing device for ejecting the aqueous ink onto the fabric; a coating device located downstream of the printing device for applying a cleaning liquid containing no eluate from the fabric to the fabric; and a removing device located downstream of the coating device of the cleaning liquid for removing the cleaning liquid.

2. The inkjet printing apparatus described in claim 1, wherein the coating device and the removing device of the cleaning liquid are installed on the same line.

3. The inkjet printing apparatus described in claim 1, wherein the coating device for applying a cleaning liquid applies the cleaning liquid to the fabric in a non-contact manner.

4. The inkjet printing apparatus described in claim 1, wherein the aqueous ink contains at least a pigment.

5. The inkjet printing apparatus described in claim 1, wherein the aqueous ink contains at least a disperse ink.

6. The inkjet printing apparatus described in claim 1, wherein the coating device of the cleaning liquid is a mist coating device or a spray coating device.

7. The inkjet printing apparatus described in claim 1, wherein the removing device of the cleaning liquid is a suction device, a blade removing device, or an air blow device.

8. The inkjet printing apparatus described in claim 1, wherein the coating device has a function of controlling a coating amount and a coating region of the cleaning liquid to be coated according to conditions.

9. The inkjet printing apparatus described in claim 8, wherein the coating device controls the coating amount and the coating region of the cleaning liquid by a type of the fabric and a printing rate of the aqueous ink.

10. The inkjet printing apparatus described in claim 1, wherein the coating device and the removing device for the cleaning liquid are installed on both sides of the fabric.

11. The inkjet printing apparatus described in claim 1, wherein the cleaning liquid applied by the coating device of the cleaning liquid contains an additive.

12. The inkjet printing apparatus described in claim 1, wherein a temperature of the cleaning liquid applied by the coating device is controlled.

13. The inkjet printing apparatus described in claim 1, wherein the cleaning liquid collected by the removing device is purified and then reused.
